(19) United States
(12) Patent Application Publication
(10) Pub. No.: US 2014/0008503 A1
(43) Pub. Date: Jan. 9, 2014

(54) PAINTING ACCESSORY SUPPORT

(71) Applicant: TRIMACO, LLC, Morrisville, NC (US)

(72) Inventors: Daniel A. Sweeney, Apex, NC (US); David C. May, Durham, NC (US); Maria P. Costello, Durham, NC (US)

(21) Appl. No.: 13/933,801

(22) Filed: Jul. 2, 2013

Related U.S. Application Data
(60) Provisional application No. 61/667,829, filed on Jul. 3, 2012.

(51) Int. Cl. B44D 3/14

(52) U.S. Cl. CPC B44D 3/14
USPC 248/211; 248/215

(57) ABSTRACT

A painting accessory support for use with a paint bucket having a handle and a ladder having a rail is disclosed. The painting accessory support includes a hook and a finger loop. The hook is sized to receive the rail of the ladder and includes a first end and a second end. The finger loop is attached to the hook between the first end and the second end. The finger loop is sized to receive a user's finger during movement of the painting accessory support from one location to another.

This application claims priority under 35 U.S.C. §119 to U.S. Provisional Application No. 61/667,829, filed Jul. 3, 2012 entitled “PAINTING-ACCESSORY SUPPORT,” which is incorporated herein by reference in its entirety.

### TECHNICAL FIELD

The present disclosure relates to a painting tool and, more particularly, to a painting accessory support for supporting paint buckets, paint sprayers, and other painting accessories above ground.

### BACKGROUND

Painting accessory supports typically include a hook and a clip configured to be coupled to a handle of a paint bucket, a paint sprayer, or other painting accessories. The hook engages a ladder step, a drainage pipe, or other structures, near a site to be painted. In operation, a user attaches the clip to a painting accessory and hangs the hook on a ladder step, for example, to support the painting accessory above ground and frees the user's hands. The user is able to move the paint bucket to other locations, as needed, by removing the hook from the ladder step and hanging the hook on another ladder step.

### SUMMARY

According to one aspect of the disclosure, a painting accessory support is disclosed. A painting accessory support includes a monolithic rod extending from a first rod end to a second rod end. The monolithic rod includes a first rod segment, a second rod segment, and a third rod segment. The first rod segment extends from the first rod end. The second rod segment extends from the second rod end. The second rod segment defines an arc. The third rod segment includes a first end connected to the first rod segment and a second end that overlaps with the first end. The second end is connected to the second rod segment. The third rod segment defines a circular opening sized to receive a finger of a user.

In some embodiments, the first rod segment may include a curved section and a shank section. The curved section may extend from the first end of the third rod segment to a section end. The shank section may extend in a straight line away from the section end of the curved section. In some embodiments, the first rod segment and the second rod segment may define a pocket.

In some embodiments, the monolithic rod may also include a first opening defined between the second rod end and the section end of the curved section of the first rod segment. In some embodiments, the first opening may define a distance between the second rod end and the section end equal to three inches.

In some embodiments, the monolithic rod may also include a second opening defined between the second rod end and the second end of the third rod segment. The first and second openings may define the pocket. In some embodiments, the second opening may define a distance between the second rod end and the second end of the third rod segment equal to two and three-fourths inches.

In some embodiments, the second rod segment may include a first center of curvature. The third rod segment may include a second center of curvature. An imaginary line may extend between the first center of curvature and the second center of curvature. The second end may overlap with the first end of the third rod segment at a point positioned on the imaginary line between the first and second centers of curvature. In some embodiments, the circular opening may have a diameter of one and three-fourths inches.

In some embodiments, the painting accessory support may also include a clip coupled to the first rod end. In some embodiments, the painting accessory support may also include a link moveably coupled between the first rod end and the clip. The link may include a flat tip configured to engage a corresponding socket.

In some embodiments, the monolithic rod may have a circular cross-section. In some embodiments, the first rod end may be formed into a flat tip configured to engage a corresponding socket.

According to another aspect of the disclosure, another embodiment of a painting accessory support is disclosed. The painting accessory support may be used with a paint bucket having a handle and a ladder having a rail. The painting accessory support includes a hook and a finger loop. The hook has a first end and a second end. The hook is sized to receive the rail of the ladder. The finger loop is attached to the hook between the first end and the second end. The finger loop is sized to receive a user's finger during movement of the painting accessory support from one location to another.

In some embodiments, the hook may include a first center of curvature. The finger loop may include a second center of curvature. The finger loop may be attached to the hook at a point positioned between the first and second centers of curvature on an imaginary line connecting the first and second centers of curvature.

In some embodiments, the hook and finger loop may be formed from a rod and the rod is bent over itself to form the hook and the finger loop. In some embodiments, the painting accessory support may also include a clip coupled to the hook and configured to be coupled to the handle of the paint bucket.

In some embodiments, the painting accessory support may also include a link coupled to the rod and to the clip. The link may include a flat tip configured to engage a corresponding socket and a platform formed to include a hole sized to receive the rod.

In some embodiments, the hook may have a round cross-section. In some embodiments, the first end may be flattened to provide a flat tip configured to engage a corresponding socket. In some embodiments, the painting accessory support may also include a shank that extends in a straight line from the hook.

According to another aspect of the disclosure, a method of constructing a painting accessory support is disclosed. The method includes providing a rod extending from a first rod end to a second rod end, bending the rod to form a finger loop, the finger loop including a first end and a second end that overlaps with the first end, bending the rod to form an arc extending between the second end of the finger loop and the second rod end, and bending the rod to form a curved leg extending between the first end of the finger loop and the first rod end. The arc and the curved leg define a hook sized to receive a rail included in a ladder.

### BRIEF DESCRIPTION OF THE DRAWINGS

The detailed description particularly refers to the accompanying figures in which:

FIG. 1 is a perspective view of a painting accessory support;

FIG. 2 is a partial elevation view of the painting accessory support of FIG. 1 attached to a ladder and supporting a paint bucket;

FIG. 3 is an elevation view of a paint sprayer coupled to the painting accessory support of FIG. 1; and

FIG. 4 is a view similar to FIG. 1 of the painting accessory support and another embodiment of a clip.

### DETAILED DESCRIPTION OF THE DRAWINGS

While the concepts of the present disclosure are susceptible to various modifications and alternative forms, specific exemplary embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives falling within the spirit and scope of the disclosure.

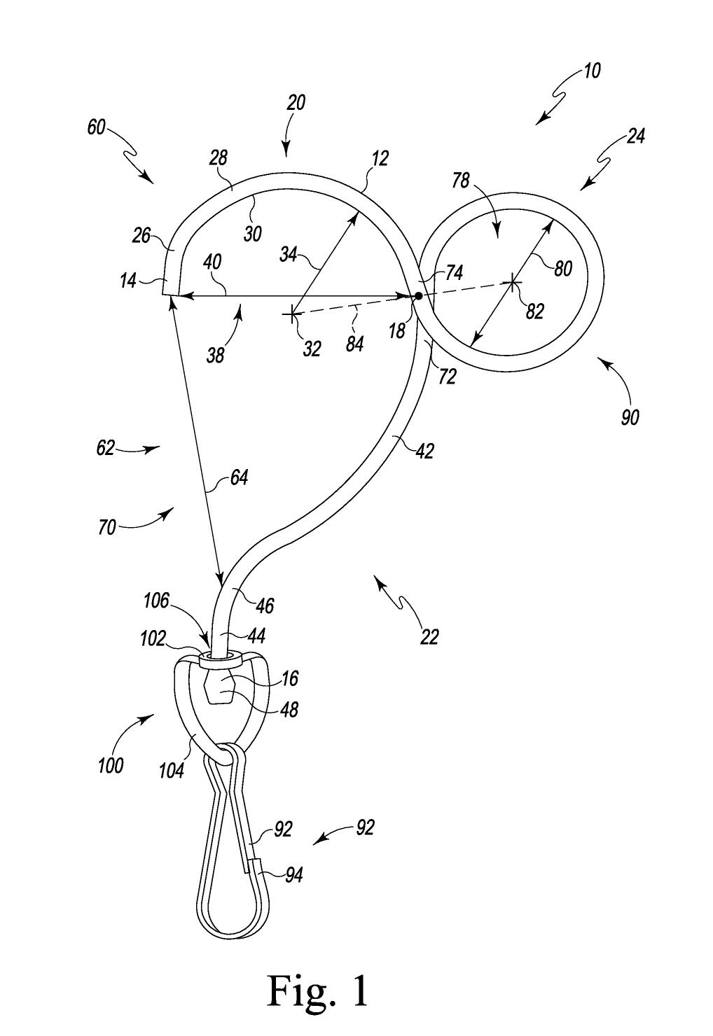

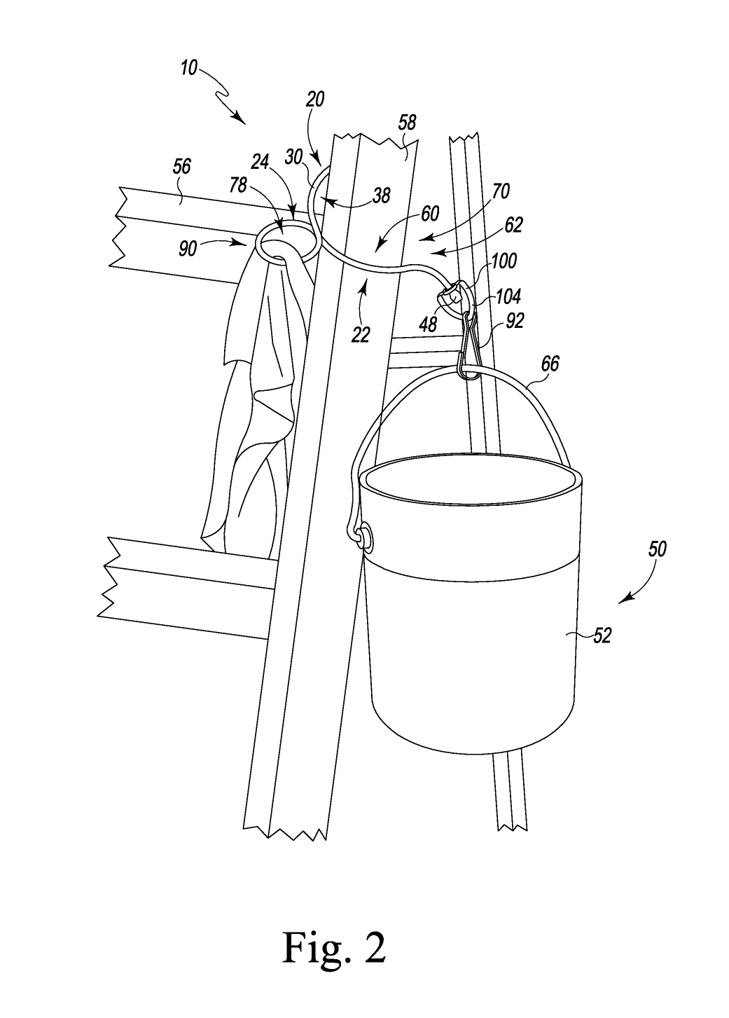

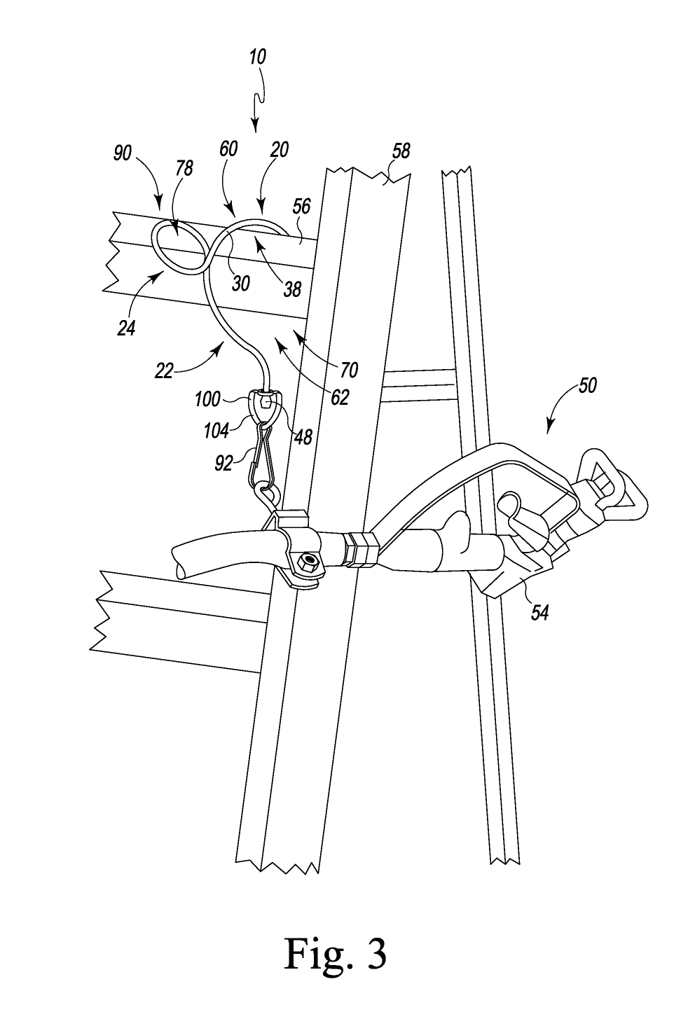

Referring to FIG. 1, a paint tool is shown as a painting accessory support 10 for supporting a painting accessory 50, such as, for example, a paint bucket 52 (see FIG. 2), a paint sprayer 54 (see FIG. 3), or other painting accessories. In the illustrative embodiment, the painting accessory support 10 includes a monolithic rod 12. The monolithic rod 12 may be made from a metallic material such as, for example, iron, steel, or brass. In other embodiments, the monolithic rod may be made from other materials, such as, rubber, plastic, or the like. In other embodiments, the rod 12 may not be monolithic; for example, the rod 12 may be a composite of a number of materials or the rod 12 may be made of a number of components welded together. In some embodiments, the monolithic rod 12 may be covered in plastic or rubber. In the illustrative embodiment, the monolithic rod 12 has a circular cross-section. In other embodiments, the monolithic rod 12 may have other cross-sections including, for example, an oval-shape or a square cross-section.

The monolithic rod 12 has an upper end 14 and a lower end 16. The monolithic rod 12 includes an upper segment 20 extending from the upper end 14, a lower segment 22 extending from the lower end 16, and a middle segment 24 connecting the segments 20, 22 at a point 18 between the ends 14, 16.

The upper segment 20 extends from the upper end 14 to the point 18. The upper segment 20 includes a shank section 26 and an arc section 28. The shank section 26 extends in a straight line away from the upper end 14 to the arc section 28. The arc section 28 is curved to define an arc 30 having a center of curvature 32 and a radius 34. In the illustrative embodiment, the arc 30 has a radius 34 of approximately one and three-eighths inches. In other embodiments, the arc 30 may be greater or less than one and three-eighths inches.

The arc 30 of the upper segment 20 defines an opening 38 that has a dimension 40. The opening 38 is sized to receive the rail 56 of the ladder 58, the drainage pipe, or other structures, near a site to be painted. In that way, the upper segment 20 is sized to engage the rail 56 of the ladder 58 (see FIG. 2), a drainage pipe, or other structures, near a paint site. In the illustrative embodiment, the dimension 40 is equal to approximately two and three-fourths inches. In other embodiments, the dimension 40 may be greater or less than two and three-fourths inches.

As described above, the monolithic rod 12 includes a lower segment 22, which extends from the lower end 16 to the point 18. The lower segment 22 includes a curved section 42 and a shank section 44. The curved section 42 extends from the point 18 to a section end 46. The shank section 44 extends in a straight line away from the section end 46 to the lower end 16. The lower end 16 is formed as a flat tip 48. The flat tip 48 is configured to engage a corresponding socket such as, for example, a groove in a flat tip screw or a groove between a paint bucket lid and paint bucket 52. In some embodiments, lower end 16 is not formed as a flat tip 48. In other embodiments, lower end 16 is formed as a Phillips head.

The upper segment 20 and the lower segment 22 cooperate to define a hook 60 for receiving and engaging the rail 56 of the ladder 58. As shown in FIG. 1, the hook 60 includes an opening 62 that is defined between the upper end 14 of the rod 12 and the section end 46 of the curved section 42. The opening 62 defines a dimension 64 and is sized to receive the rail 56 of the ladder 58, a drainage pipe, or other structures, near a site to be painted. In the illustrative embodiment, the dimension 64 is equal to approximately three inches. In other embodiments, the dimension 64 may be greater than or less than three inches.

The opening 38 and the opening 62 define a pocket 70 in the hook 60. The rail 56 of the ladder 58, for example, is received by the opening 62 of the pocket 70 when the painting accessory support 10 is attached to the ladder 58. The rail 56 is moved through the opening 38 of pocket 70 and engages upper segment 20 to support the painting accessory support 10 on the rail 56.

As described above, the monolithic rod 12 includes a middle segment 24 that connects the upper segment 20 with the lower segment 22. The middle segment 24 includes an end 72 and an end 74. The end 72 is connected to the lower segment 22 and the end 74 is connected to the upper segment 20. In the illustrative embodiment, the middle segment 24 defines a circular opening 78 sized to receive a finger of a user. To form the middle segment 24, the monolithic rod 12 is bent over itself such that the end 74 overlaps the end 72 at the point 18, as described in greater detail below. The circular opening 78 has a diameter 80 centered about a center of curvature 82. In the illustrative embodiment, the diameter 80 is equal to approximately one and three-fourths inches. In other embodiments, the diameter 80 may be greater or less than one and three-fourths inches.

As shown in FIG. 1, an imaginary line 84 extends through the center of curvature 32 of the upper segment 20 and the center of curvature 82 of the middle segment 24. In the illustrative embodiment, the point 18 is positioned on the imaginary line 84 between the centers of curvature 32, 82. The end 74 of the middle segment 24 overlaps with the end 72 at the point 18.

The middle segment 24 forms a finger loop 90, which is attached to the hook 60 between the upper end 14 and the lower end 16. In the illustrative embodiment, the finger loop 90 is attached to the hook 60 because the finger loop 90 and the hook 60 are formed from the monolithic rod 12. In other embodiments, the finger loop 90 may be welded to the hook 60. In yet other embodiments, the hook 60 and the finger loop 90 may be formed in a molding process.

As shown in FIG. 1, the painting accessory support 10 further includes a clip 92 coupled to the lower end 16. The clip 92 is configured to couple to the painting accessory 50 such as, for example, a handle 66 of the paint bucket 52. The clip 92 is removable from the lower end 16 of the rod 12 and, thus, the clip 92 may be replaced with one or more of a number of types of clips. The clip 92 includes a first clip end 94 and second clip end 96. The clip 92 is formed such that the first clip end 94 overlaps the second clip end 96. The second clip end 96 is biased into engagement with the first clip end 94. In other embodiments, the painting accessory support 10 may not include the clip 92. In some embodiments without the clip 92, the painting accessory support 10 includes a lower hook attached to the lower end 16.

The painting accessory support 10 also includes a link 100, as shown in FIG. 1. The link 100 is movably coupled to the rod 12 between the lower end 16 and the point 18 such that the link 100 is able to both rotate about and translate along the lower segment 22 of the rod 12. The link 100 includes a platform 102 and a flat tip 104. The platform 102 is formed to include a hole 106, which receives the lower end 16 of the rod 12. The flat tip 104 of the link 100 is configured to engage a corresponding socket such as, for example, a groove between the paint bucket lid and the paint bucket 52.

The painting accessory support 10, as shown in FIG. 1, is formed by providing an approximately straight monolithic rod 12 and bending the lower end 16 of the rod 12 over the upper end 14 of the rod so that the lower end 16 overlaps with the upper end 14 to form the finger loop 90. The rod 12 is bent at the upper end 14 to form the shank section 26 of the upper segment 20. The upper segment 20 is bent between the shank section 26 and the finger loop 90 to form the arc 30. The lower end 16 of the rod 12 is bent to form the shank section 44 of the lower segment 22. The lower segment 22 is bent between the section end 46 and the finger loop 90 to form the curved section 42.

The lower end 16 is inserted into the hole 106 of the link 100, and the lower end 16 is flattened to form the flat tip 48. The lower end 16 may be flattened, for example, by pressing the lower 16 of the rod 12. The clip 92 is attached to the flat tip 104 of the link 100.

Referring now to FIG. 2, one exemplary use of the painting accessory support 10 is shown. In operation, the user attaches a painting accessory 50, such as, for example, the paint bucket 52, to the clip 92 by clipping the handle 66 of the paint bucket 52 to the clip 92. With the paint bucket 52 attached to the painting accessory support 10, the user is able to move and support the paint bucket 52 with the painting accessory support 10.

The user grips the finger loop 90 of the painting accessory support 10 with one or more fingers and moves the painting accessory support 10 toward the rail 56 of the ladder 58. The user moves the painting accessory support 10 so that the rail 56 is received by the opening 62 of the pocket 70. The user lowers the painting accessory support 10 until the rail 56 is received in opening 38 and engages the arc 30 of the upper segment 20. The user then releases the finger loop 90 and the paint bucket 52 is supported by the painting accessory support 10, freeing the user's hands, as shown in FIG. 2.

The user is able to grip the finger loop 90 of the painting accessory support 10 to lift the painting accessory support 10 and the paint bucket 52 away from the rail 56. The user may then attach the painting accessory support 10 to another rail 56 or other structure as the user moves about the paint site.

Referring to FIG. 3, the painting accessory support 10 is shown supporting the paint sprayer 54. The user attaches the paint sprayer 54 to the clip 92. With the paint sprayer 54 attached to the clip 92, the user is able to move and attach the clip 92 to the rail 56 of the ladder 58 or other structures. The finger loop 90 extends away from the ladder 58 and allows the user to grip the finger loop 90 with one or more fingers from a number of angles.

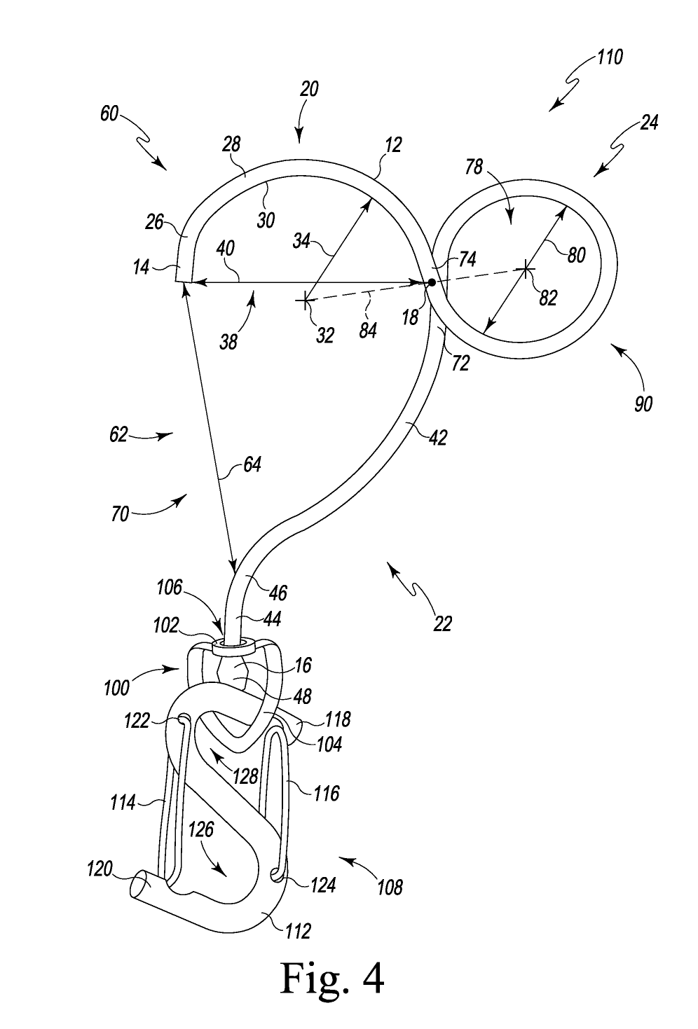

Referring to FIG. 4, a painting accessory support 110 with another embodiment of a clip 108 is shown. The painting accessory support 110 is similar to painting accessory support 10 except for the clip 108. The painting accessory support 110 includes the monolithic rod 12 and the link 100.

The clip 108 includes an S-shaped body 112, an outer arm 114, and an inner arm 116. The S-shaped body 112 includes an upper end 118, a lower end 120, an upper attachment point 122, and a lower attachment point 124. The S-shaped body 112 includes an opening 126 defined between the upper attachment point 122 and the lower end 120 and an opening 128 defined between the lower attachment point 124 and the upper end 118.

The outer arm 114 is pivotably coupled to the upper attachment point 122 and is biased toward the lower end 120 of the S-shaped body 112 to close the opening 126. Similarly, the inner arm 116 is pivotably coupled to the lower attachment point 124 and is biased toward the upper end 118 of the S-shaped body 112 to close the opening 128.

Either arm 114, 116 may be depressed to allow access to the openings 126, 128. The painting accessory 50 may be inserted into the openings 126, 128 and then the arms 114, 116 released to clip the painting accessory 50 to the clip 108.

There are a plurality of advantages of the present disclosure arising from the various features of the method, apparatus, and system described herein. It will be noted that alternative embodiments of the method, apparatus, and system of the present disclosure may not include all of the features described yet still benefit from at least some of the advantages of such features. Those of ordinary skill in the art may readily devise their own implementations of the method, apparatus, and system that incorporate one or more of the features of the present invention and fall within the spirit and scope of the present disclosure.

1. A painting accessory support comprising:
a monolithic rod extending from a first rod end to a second rod end, the monolithic rod comprising:
(i) a first rod segment extending from the first rod end,
(ii) a second rod segment extending from the second rod end, the second rod segment defining an arc, and
(iii) a third rod segment including a first end connected to the first rod segment and a second end that overlaps with the first end, the second end being connected to the second rod segment,
wherein the third rod segment defines a circular opening sized to receive a finger of a user.

2. The painting accessory support of claim 1, wherein the first rod segment includes a curved section extending from the first end of the third rod segment to a section end and a shank section extending in a straight line away from the section end of the curved section.

3. The painting accessory support of claim 2, wherein the first rod segment and the second rod segment define a pocket.

4. The painting accessory support of claim 3, wherein the monolithic rod further comprises a first opening defined between the second rod end and the section end of the curved section of the first rod segment.

5. The painting accessory support of claim 4, wherein the monolithic rod further comprises a second opening defined between the second rod end and the second end of the third rod segment, the first and second openings defining the pocket.

6. The painting accessory support of claim 1, further comprising a clip coupled to the first rod end.

7. The painting accessory support of claim 6, further comprising a link moveably coupled between the first rod end and the clip, the link including a flat tip configured to engage a corresponding socket.

8. The painting accessory support of claim 1, wherein the monolithic rod has a circular cross-section.

9. The painting accessory support of claim 1, wherein the first rod end is formed into a flat tip configured to engage a corresponding socket.

10. A painting accessory support for use with a paint bucket having a handle and a ladder having a rail, the painting accessory support comprising:
a hook having a first end and a second end, the hook sized to receive the rail of the ladder, and
a finger loop attached to the hook between the first end and the second end, the finger loop being sized to receive a user's finger during movement of the painting accessory support from one location to another.

11. The painting accessory support of claim 10, wherein the hook and the finger loop are formed from a rod and the rod is bent over itself to form the hook and the finger loop.

12. The painting accessory support of claim 10, further comprising a clip coupled to the hook and configured to be coupled to the handle of the paint bucket.

13. The painting accessory support of claim 12, further comprising a link coupled to the rod and to the clip and the link includes a flat tip configured to engage a corresponding socket and a platform formed to include a hole sized to receive the rod.

14. The painting accessory support of claim 10, wherein the hook has a round cross-section.

15. The painting accessory support of claim 10, wherein the first end is flattened to provide a flat tip configured to engage a corresponding socket.

16. The painting accessory support of claim 10, further comprising a shank that extends in a straight line from the hook.

17. A method of constructing a painting accessory support comprising:
providing a rod extending from a first rod end to a second rod end,
bending the rod to form a finger loop, the finger loop including a first end and a second end that overlaps with the first end,
bending the rod to form an arc extending between the second end of the finger loop and the second rod end, and
bending the rod to form a curved leg extending between the first end of the finger loop and the first rod end, the arc and the curved leg defining a hook sized to receive a rail included in a ladder.
